(19) United States
(12) Patent Application Publication
(10) Pub. No.: US 2016/0104182 A1
(43) Pub. Date: Apr. 14, 2016

(54) Digital Advertising Mark-to-Market Data Solicitation and Pricing Process

(71) Applicant: Harish Sivachandra Vallury, Massapequa, NY (US)

(72) Inventor: Harish Sivachandra Vallury, Massapequa, NY (US)

(21) Appl. No.: 14/492,117

(22) Filed: Oct. 14, 2014

(51) Int. Cl. G06Q 30/02

(52) U.S. Cl. CPC G06Q 30/0206; G06Q 30/0241

(57) ABSTRACT

A method and process schematic for the fair-valuation of digital advertising exchange prices for digital advertising inventory. The digital mark-to-market pricing process seeks to provide composite pricing as catalogue values for the digital advertising market, by designated market area, advertising category, and device. The process of aggregating and actual market prices quoted by digital advertising industry players, and then calculating a composite average price for the intersection of both designated marketing area (DMA) and category (or “vertical”), is a unique one. While formulas can vary, the theoretical application of compiling effective cost per mille (eCPM) price quotes from various parties, including direct advertisers, demand-side platforms (DSPs), and advertising agency trading desks (ATDs), then determining a composite average of these price quotes to determine a fair value composite average price, is the primary objective of this “mark-to-market” data solicitation and pricing process.

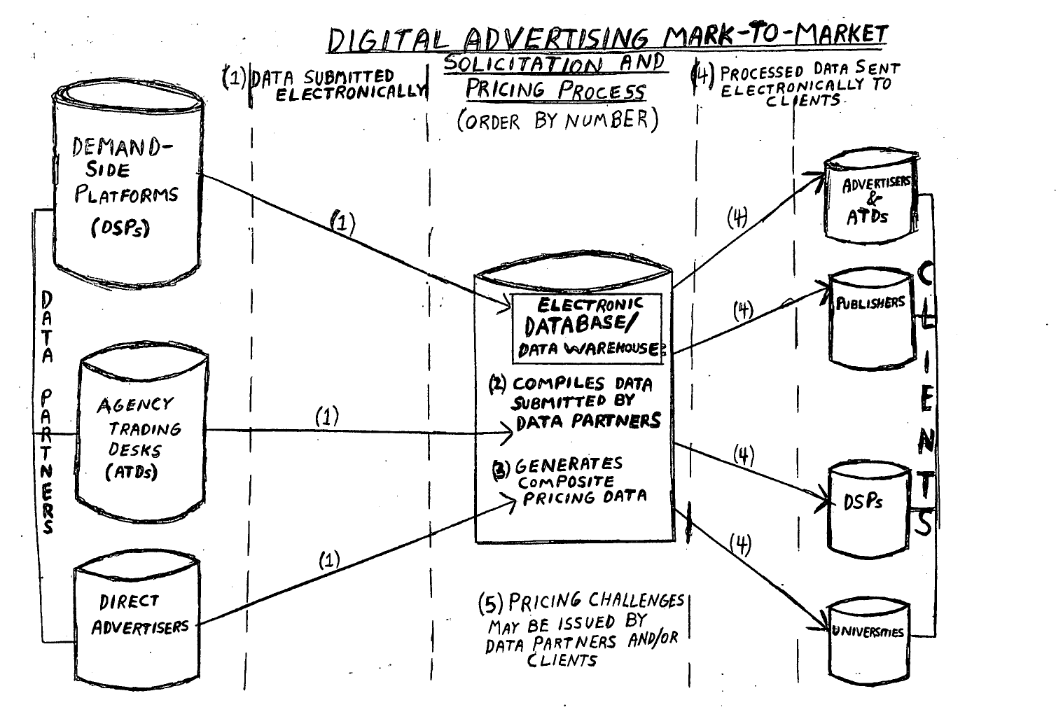

### TECHNICAL FIELD

Certain embodiments of the present disclosure generally relate to digital advertising and, more particularly, to the provision of pricing transparency within the digital advertising market.

### BACKGROUND

The digital advertising industry often services direct marketers through various channels, including through advertising agencies, advertising networks, demand-side technology platforms (or DSPs), and agency trading desks. The incorporation of one or more of these entities as partners for advertising solutions by a single direct marketer, can lead to inconsistent price quotes across similar publisher inventory. There is also very little or no transparency into the pricing schema of purchasing inventory across various categories and channels.

Often, pricing becomes inflated, as these various partner entities utilize connections and partners of their own as ways of obtaining inventory that would otherwise be inaccessible. This is mainly because partnerships between publishers and their inventory, and the various entities that service direct advertisers, are not equal for all firms. These entities that service direct marketers develop relationships with one another that allow for an extension of their reach for publisher inventory that would otherwise be inaccessible to them.

The result of this is that pricing becomes largely inflated, as arbitrage opportunities arise, and the direct marketer suffers the end-cost of this inflation process, and due to lack of transparency, the direct marketers are often unaware of how this inflation due to arbitrage had taken place. Many institutions and firms, such as the Internet Advertising Bureau and AdFin, respectively, have tried to address the pricing transparency issue, but have not been successful at determining an effective means of deriving fair market values that can be used as benchmark prices.

### SUMMARY OF THE DISCLOSURE

The pricing process I have derived incorporates the information flow from what are considered “partner” entities, or entities that have the potential to submit their aggregated data to be processed within and disseminated by a single data warehouse, or database. I have derived this idea based on experiences with fixed income composite pricing valuations, and the recognition for a need for fair value pricing within the digital advertising industry. This process involves the simple but effective and untapped process of aggregating pricing data by specific inventory categories, or verticals (as they are called), designated marketing areas (DMAs), and by the platform type of inventory, whether it is display, mobile, or social media. The process involves taking pricing from these contributing partners, aggregating them based on the specific groupings they belong to, based on vertical, DMA, and the platform, and deriving a composite price for the inventory, which can be used as a fair-value, benchmark price.

The crude pricing data is solicited/obtained from contributing partners, which include demand-side platform technology companies, supply-side platform companies, agency trading desks, and agencies, by e-mail or file transfer protocol. A simple formula to aggregate the price quotes, and determine an average, fair value price by deriving the sum by the total number of contributors, would be used to calculate a fair-value, mean-of-mean pricing for digital advertising inventory pricing for a given vertical, DMA, and platform, on a daily basis. The processed data would then be compiled into client-specific files, based on each client's preferences, and disseminated via e-mail or file transfer protocol (FTP). The contributing partners for each price quote will also be noted next to each mark with abbreviations of their names as verification that there are legitimate sources for the price. However, if there are less than three contributors, only the number will be noted to protect their anonymity if there is low price coverage. If there are three or more, their initials will be listed, separated by commas. In any circumstance, a specific quote will never be associated to a specific contributor to clients or any external parties; it will only be internally noted.

Clients as well as contributing partners would reserve the right to challenge daily prices for any given sub-categories. They would have 23 business hours to submit a challenge on fair value prices within the derived catalogue. To address these challenges, contributing partners would be asked to verify the accuracy of the price marks they are submitting for the next given business day. Based on the most current prices, daily pricing for each vertical, designated marketing area, and platform, will be updated for the next day, based on the new composite averages. The process repeats for all business days.

### BRIEF DESCRIPTION OF THE DRAWING

Reference will now be made to the drawing, which shows, by way of example, embodiments of the present disclosure. On the drawing, each Figure (or Step), is noted in numerical sequence, illustrating the process flow, embodied by the disclosure.

FIG. (Step) 1 represents the process of data partners, which include demand-side platform technology firms (DSPs), agency trading desks (ATDs), and even direct advertisers themselves, submitting pricing data on media-buying transactions for the past 24 hours to the aggregating electronic database/warehouse, via electronic transmission through e-mail and/or file-transfer protocol (FTP).

FIG. (Step) 2 represents the process of the data warehouse using the pricing data received from contributing partners via e-mail and/or FTP, and compiling that data based on vertical category, designated marketing area (DMA), and platform (display web, mobile, or social inventory). The data is compiled based on the cross-section of these venues, by aggregating prices from each contributor, and then dividing by the total number of contributors for that given cross-section. The final pricing product is represented generally by Step (3).

FIG. (Step) 4 represents the process of the data warehouse compiling the derived pricing data and sending it electronically via e-mail and/or FTP to various client parties, including direct advertisers, ATDs publishers, DSPs, and even educational institutions such as universities and colleges. Step (5) represents the possibility of these client parties and even contributing partners challenging daily prices for any given sub-categories. Based on this event, the process would cycle through again from Step (1) and onward either way.

### DETAILED DESCRIPTION

Embodiments of the present disclosure will allow for an aggregation, calculation, and valuation of market-produced price quotes of digital inventory by actual market contributors, that are combined together based on similar attributes, in terms of inventory category (or vertical) and designated market area, or DMA (geography).

The methods and system schematic of the present disclosure may be utilized within the digital advertising exchange (or Real-Time Bidding) environment. As used herein, the term “mark-to-market pricing” generally refers to the process of soliciting price quotes from market contributors, compiling and valuating composite averages, and disseminating to clients and interested market parties.

FIG. (Step) 1 illustrates an example of data being submitted electronically, whether it be through a database-to-database API integration, processed data files sent by e-mail, or processed data files sent via file transfer protocol (FTP). The term “Data Partners” refers to partners who service buy-side clients, who are typically the ones seeking to advertise either on their own behalf, or on the behalf of an advertiser client. These parties include technology companies known as “Demand-Side Platforms (DSPs)”, Advertising Agencies, Advertising Agency Trading Desks, and direct advertisers, themselves.

FIG. (Step) 2 illustrates the collection of the data submitted through the means outlined in the previous paragraph. This data is compiled via an internal database/data warehouse, such as a SQL-driven database, or Microsoft Access, etc.

FIG. (Step) 3 illustrates the database's series of queries, macros, and modules that will assist in the compilation, calculation, and valuation of composite prices, based on data submitted from partners, based on vertical and DMA categorization. Within the database, this process will be referred to as the “Pricing and Valuation Process.” The final product will be in the form of historical data tables for organized data for that given day, and will also be parsed into client-specific files, which will be dictated by client demand for specific data types.

FIG. (Step) 4 illustrates the dissemination of the finished data files or information to the various parties, as examples, of what embody the definition of “Clients,” in this context. These clients include direct advertisers, publishers, DSPs, advertising agencies, advertising agency trading desks, and even educational universities and colleges, as well as other academic and research institutions. The clients will also be given within their data, the exact number of contributing partners, who provided their prices for a specific vertical and DMA combination quote. If there are less than 3 contributors, no names will be given, just the number of contributors. If there are more than 3 contributors, then the names, or recognizable initials of the contributing brokers will be given. In ANY circumstance, no specific quotes will ever be associated with a specific contributor.

FIG. (Step) 5 illustrates a conditional step, which would include any clients, or contributors, whether on the buy or sell-side, who feel that the data is not indicative of actual market prices. They reserve the right, within 24 hours of the previous pricing and valuation process, to “challenge,” or question the validity of pricing valuations for a particular vertical and DMA combination. The process includes collecting data from data partners, as outlined in step 1, but actually verifying that the data, or “quotes” that they are providing are authentic, accurate, and up-to-date. Once data is verified, the processes cycle through as outlined in the previous paragraphs (steps 1 thru 4, with the possibility of step 5), for each week day of the week.

What is claimed is:

1. The process of soliciting specific data presented in electronic spreadsheets, submitted electronically (e-mail and/or file transfer protocol). The specific data can include eCPM, the average winning prices for a given designated market area and category, as well as device type.

2. This submitted data will be compiled and added with data for matching designated market areas and categories from other submitting parties. This will allow for composite prices to be derived by adding similarly categorized data together, and then divided by the total number of contributing partners. With a composite price available after this mathematical process, this essentially represents a fair value price.

3. The fair value prices will then be arranged in electronic spreadsheets, with custom data being available for clients, in arrangements of their own specifications. The data can be sent to them electronically via e-mail and/or file transfer protocol. These clients include direct advertisers, advertising agency trading desks, advertising agencies, demand-side platforms, and even educational institutions, such as universities and colleges.

4. Clients and data-submitting partners, alike, will have the ability to challenge end-of-day composite prices. The next day, by collecting “fresh” marks from data-contributing partners, fresh composite prices will be derived, thus either affirming or refuting challenge claims, while still fulfilling daily demand for fair value pricing. The method of contributor disclosure to clients, by not disclosing any contributors for a given quote if less than three total contributors, or giving initials if three or greater, as well as never associating a specific quote to a specific contributor under any circumstance to external parties, is also key. The aforementioned process cycle will repeat on a daily basis, and data can be provided on a daily basis, or arranged by different time intervals for historical data.
